(19) United States
(12) Patent Application Publication
(10) Pub. No.: US 2025/0298554 A1
(43) Pub. Date: Sep. 25, 2025

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventors: Hisao KOMAZAWA, Kanagawa (JP); Akiho YASUDA, Kanagawa (JP)

(73) Assignee: FUJIFILM Business Innovation Corp., Tokyo (JP)

(21) Appl. No.: 18/804,193

(22) Filed: Aug. 14, 2024

(30) Foreign Application Priority Data
Mar. 25, 2024 (JP) 2024-048545

(51) Int. Cl. G06F 3/12; G06K 15/02

(52) U.S. Cl. CPC G06F 3/1208; G06F 3/1254; G06K 15/1823

(57) ABSTRACT

An information processing system includes: a processor configured to: when new input information including information on a new print job or information on a printer is input to a model, output a printing speed of the new print job, wherein the model has been learned such that a printing speed of a print job is output when input information including information on the print job or information on the printer including an inspection apparatus inspecting a printed material printed in the print job is input to the model.

### CROSS-REFERENCE TO RELATED APPLICATIONS

This application is based on and claims priority under 35 USC 119 from Japanese Patent Application No. 2024-048545 filed Mar. 25, 2024.

### BACKGROUND

### (i) Technical Field

The present disclosure relates to an information processing system, a non-transitory computer readable medium and an information processing method.

### (ii) Related Art

Japanese Unexamined Patent Application Publication No. 2023-136927 discloses a printed material inspection system. The printed material inspection system includes a processor that inspects quality of a printed material and a display that displays results of the inspection. The processor reads and executes a program and is thus configurated to compare a scan image with a reference image. The scan image is obtained by scanning a printed material of a page serving as an inspection target from among pages configurating a job. The reference image is produced by using rasterized data of the page serving as the inspection target. The processor is further configurated to inspect a first defect in the scan image at a first inspection level that is a predetermined default level or a level set by a user, automatically inspect a second defect in the scan image at a second inspection level different from the first inspection level and display on the display the first defect and second defect in an identifiable manner.

Some printers may be equipped with an inspection function that inspects a rasterized image at the production of print data and a scan image at printing. Such inspection function discards all printed sheets on a paper sheet path when a fault is detected in inspection results and reprinting is performed starting with a sheet that is detected as the fault in the inspection results.

If an image quality or productivity is higher than a predetermined level, there is a trade-off relationship between the image and productivity. For example, the productivity depends on a print speed. Depending on a print job with the printing speed increasing, the image quality may be reduced, the possibility of the fault in inspection result may be increased and an amount of waste sheets may increase. An optimum printing speed may be set to maintain an appropriate image quality.

### SUMMARY

Aspects of non-limiting embodiments of the present disclosure relate to providing an information processing system, a non-transitory computer readable medium and an information processing method which may estimate a printing speed of a print job through inspection of a printed material on a printer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a processor configured to: when new input information including information on a new print job or information on a printer is input to a model, output a printing speed of the new print job, wherein the model has been learned such that a printing speed of a print job is output when input information including information on the print job or information on the printer including an inspection apparatus inspecting a printed material printed in the print job is input to the model.

### BRIEF DESCRIPTION OF THE DRAWINGS

Exemplary embodiment of the present disclosure will be described in detail based on the following figures, wherein:

FIG. 1 schematically illustrates an information processing system of an exemplary embodiment;

FIG. 2 is a block diagram illustrating an electrical configuration of a printer in the information processing system of the exemplary embodiment;

FIG. 3 is a block diagram illustrating an electrical configuration of a management apparatus and client computer in the information processing system of the exemplary embodiment;

FIG. 4 is a block diagram illustrating a functional configuration of the client computer in the information processing system of the exemplary embodiment;

FIG. 5 illustrates an example of a learned neural network model;

FIG. 6 is a flowchart illustrating a process flow example of a learning process performed on the client computer in the information processing system of the exemplary embodiment; and

FIG. 7 is a flowchart illustrating a process flow example of an estimation process performed on the client computer in the information processing system of the exemplary embodiment.

### DETAILED DESCRIPTION

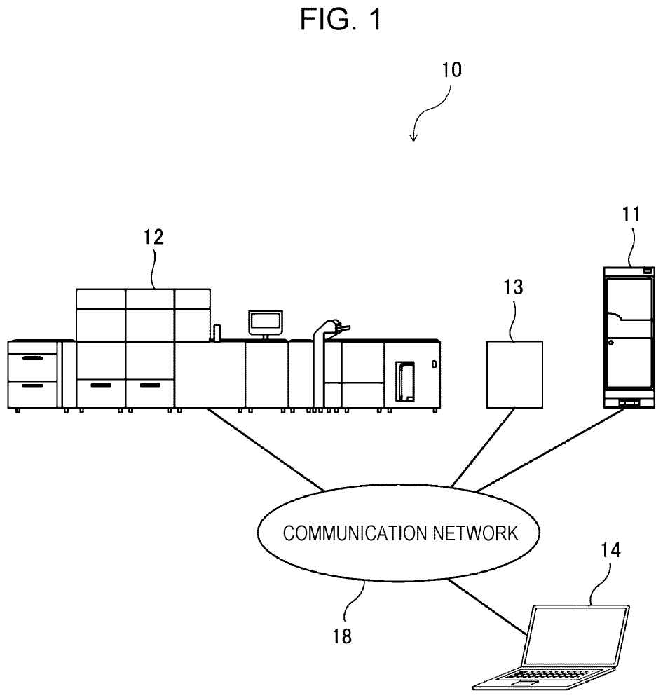

Exemplary embodiment of the disclosure is described below with reference to the drawings. The exemplary embodiment is related to an information processing system 10 including a management apparatus, printer, client computer and the like connected to each other via a communication network, including a variety of networks. FIG. 1 schematically illustrates the information processing system 10 of the exemplary embodiment.

Referring to FIG. 1, the information processing system 10 of the exemplary embodiment includes a management apparatus 11, printer 12, inspection apparatus 13, client computer 14 and the like. The management apparatus 11, printer 12, inspection apparatus 13 and client computer 14 are connected to each other via a communication network 18 including a local-area network (LAN), wide-area network (WAN), Internet and/or Intranet. The management apparatus 11, printer 12, inspection apparatus 13 and client computer 14 may exchange a variety of data with each other via the communication network 18. According to the exemplary embodiment, the printer 12 performs printing responsive to a print instruction when the print instruction is provided to the printer 12 from the client computer 14 via the management apparatus 11.

Referring to FIG. 1, each of the management apparatus 11, printer 12, inspection apparatus 13 and client computer 14 is a single standalone apparatus but at least one of these apparatus may be a multi-apparatus system.

The printer 12 of the exemplary embodiment has multiple functions including a printing function that performs a printing process, a post-process function that performs a post-process on the printed paper and other functions. The multiple functions may include a reading function that obtains image information representing a document by reading the document, a copying function that copies an image recorded on a document to a paper sheet, a facsimile function that transmits or receives a variety of data via a telephone network (not illustrated), a transfer function that transfers document information, such as image information that is read by the reading function, and a storage function that stores the read image information.

In the following discussion, the facsimile function, reading function, printing function and copying function may be occasionally respectively referred to as fax, scan, print and copy.

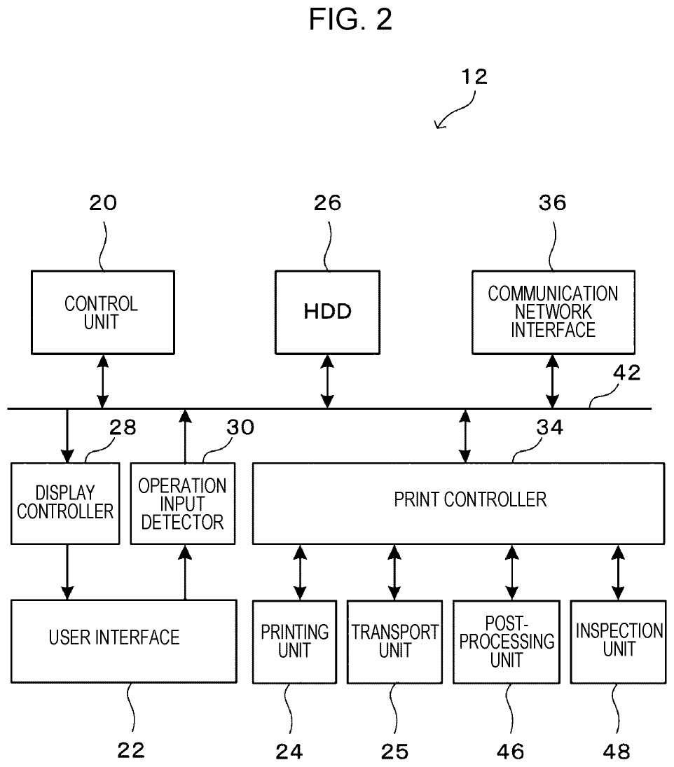

FIG. 2 is a block diagram illustrating an electrical configuration of the printer 12 in the information processing system 10 of the exemplary embodiment.

Referring to FIG. 2, the printer 12 of the exemplary embodiment may include a control unit 20. The control unit 20 may include a central processing unit (CPU), read-only memory (ROM) and random-access memory (RAM).

The printer 12 of the exemplary embodiment further includes a hard disk drive (HDD) 26 that stores a variety of data and application programs. The printer 12 further includes a display controller 28 that is connected to a user interface 22 and controls displaying of a variety of screens on a display of the user interface 22. The printer 12 further includes an operation input detector 30 that is connected to the user interface 22 and detects an operation instruction input via the user interface 22. In the printer 12, a system bus 42 is electrically connected to the HDD 26, display controller 28 and operation input detector 30. In the printer 12 of the exemplary embodiment, a memory is the HDD 26 but alternatively, may be a non-volatile memory, such as a flash memory. In the exemplary embodiment, the user interface 22 is a touch panel that serves as a display capable of receiving an operational input but alternatively, the user interface 22 may include a display and an operation unit that are separate from each other.

The printer 12 of the exemplary embodiment includes a print controller 34 that controls a printing process of a printing unit 24, transport operation of a transport unit 25 transporting a paper sheet to the printing unit 24, post-process of a post-processing unit 46, and reading operation of an inspection unit 48 reading a printed material. The printer 12 may further include a reading controller that controls a reading operation of an optical document reader optically reading an image and a document transport operation of a document transport unit. The printer 12 is connected to the communication network 18 and further includes a communication network interface 36 that exchanges communication data with the client computer 14 connected to the communication network 18 or another external apparatus connected to the communication network 18. The printer 12 connected to a telephone line (not illustrated) may include a fax interface 38 that exchanges fax data with a fax device connected to the telephone line. The printer 12 may include a transmission-reception controller that controls transmission and reception of the fax data via the fax interface 38. The print controller 34 and communication network interface 36 are electrically connected to a system bus 42 in the printer 12.

The control unit 20 in the printer 12 of the exemplary embodiment thus configurated controls an operation screen of the display of the user interface 22 and a display operation of information, such as a variety of messages via the display controller 28. The control unit 20 in the printer 12 controls operations of the printing unit 24, transport unit 25, post-processing unit 46 and inspection unit 48 via the print controller 34 and exchange of the communication data via the communication network interface 36. The control unit 20 in the printer 12 recognizes operation contents on the user interface 22 in accordance with operation information detected by the operation input detector 30 and thus performs a variety of controls in response to the operation contents.

Applications stored on the HDD 26 include, for example, an application for printing.

When the printer 12 performs printing in accordance with print information, the inspection apparatus 13 inspects a printed material by comparing a raster image represented by the print information with a scan image of the printed material obtained by the inspection unit 48.

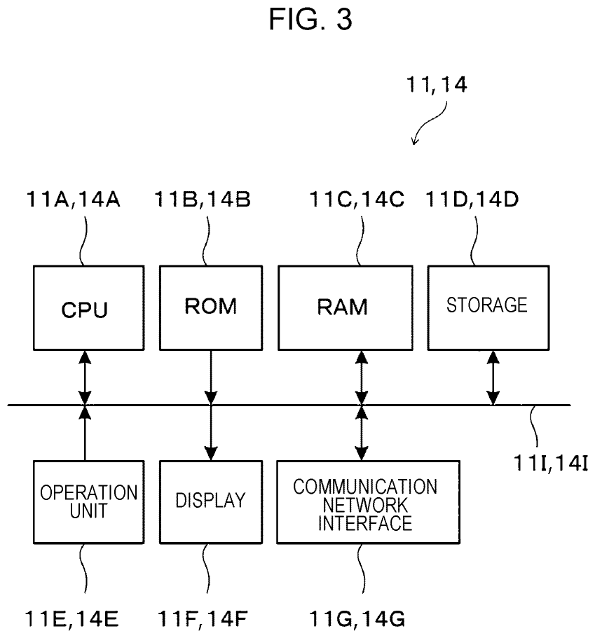

The electrical configuration of the management apparatus 11 and client computer 14 of the exemplary embodiment is described below. FIG. 3 is a block diagram illustrating the electrical configuration of the management apparatus 11 and client computer 14 in the information processing system 10 of the exemplary embodiment. The management apparatus 11 and client computer 14 have a typical computer configuration and only the management apparatus 11 is described herein.

As illustrated in FIG. 3, the management apparatus 11 of the exemplary embodiment includes a CPU 11A, ROM 11B, RAM 11C, storage 11D, operation unit 11E, display 11F and communication network interface 11G. The CPU 11A controls the whole operation of the management apparatus 11. The ROM 11B pre-stores a variety of control programs and a variety of parameters. The RAM 11C is used as a working area when the CPU 11A executes the programs. The storage 11D stores a variety of data and application programs. The operation unit 11E is used to input a variety of information. The display 11F is used to display a variety of information. The communication network interface 11G is connected to the communication network 18 and exchanges a variety of data with another apparatus connected to the communication network 18. The communication network interface 11G may be configurated to communicate with apparatuses using a variety of wireless communications of the related art. The elements of the management apparatus 11 described above are electrically connected to each other via a system bus 11I. The storage 11D is used in the management apparatus 11 of the exemplary embodiment but alternatively, a non-volatile memory, such as an HDD or flash memory, may be used in the management apparatus 11.

The CPU 11A in the management apparatus 11 of the exemplary embodiment thus configurated accesses the ROM 11B, RAM 11C and storage 11D, retrieves a variety of data from these memories via the operation unit 11E and displays a variety of information on the display 11F. The CPU 11A in the management apparatus 11 controls exchange of communication data via the communication network interface 11G.

The management apparatus 11 in the information processing system 10 thus configurated manages a series of manufacturing processes. The series of manufacturing processes include a production process, pre-press process, pressplate process, printing process, processing process and delivery process.

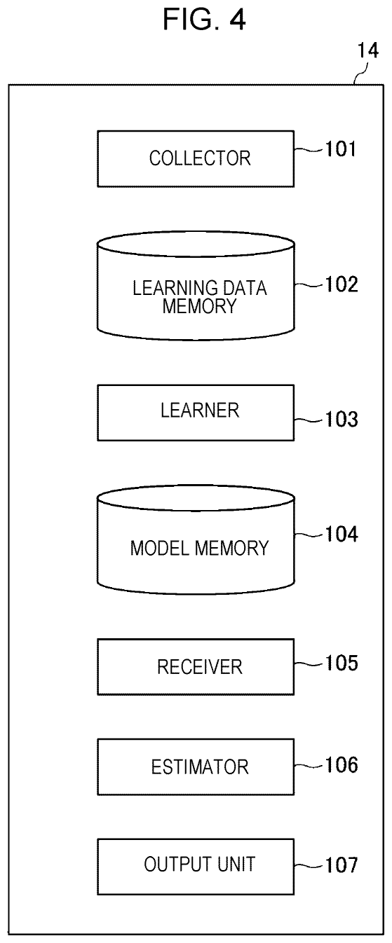

Functional configuration of the client computer 14 is described below. FIG. 4 is a block diagram illustrating the functional configuration of the client computer 14.

The client computer 14 is functionally configurated as illustrated in FIG. 4 to include a collector 101, learning data memory 102, learner 103, model memory 104, receiver 105, estimator 106 and output unit 107.

The collector 101 collects learning data including input information on a past print job paired with the printing speed of the driver 12 responsive to the input information.

The input information may include information on the print job. Specifically, the information on the print job may include a raster image representing a printed material and generated prior to printing or information on a setting of the print job. The information on the setting of the print job may include the presence or absence of special toner, type of printing paper, type of a paper feed tray, type of printing paper or type of a paper output tray. For example, the types of the printing paper may include coated paper, matt coated paper, 90 kg of high-quality paper, 110 kg of high-quality paper, Naga 3 type envelope (120 mm×235 mm), Naga 4 type envelope (90 mm×205 mm), Yonaga 3 type envelope (155 mm×105 mm), Kaku 3 type envelope (216 mm×277 mm), Kaku 4 type envelope (197 mm×267 mm), transfer form, ledger paper, regular postcard, double postcard, and New Year's postcard.

The inspection apparatus 13 stores information on orders of printed materials, manufacturing information and log information used to manage an inspection log.

The collector 101 collects from the log information stored on the management apparatus 11 information on raster images of past print jobs and information on settings of the print jobs.

The input information may include information on the printer 12. Specifically, the information on the printer 12 includes information on a pre-process or post-process, information on the configuration of the printer 12 or information on operating time of the driver 12.

The information on the pre-process includes the type of the pre-process or the presence or absence of the pre-process and the type of the pre-process includes a preprint, paper feeding or the like. The information on the post-process includes the type of the post-process or the presence or absence of the post-process and the type of the post-process includes a post-print, paper feeding or the like.

The information on the configuration of the printer 12 includes distances between devices for the pre-process, printing process, post-process and delivery.

The information on the operating time includes cumulative operating time of the driver 12 or continuous operating time of the driver 12.

The collector 101 retrieves from the log information stored on the management apparatus 11 information on the pre-process or post-process, information on the configuration of the driver 12 and information on the operating time of the printer 12.

The collector 101 retrieves from the log information stored on the management apparatus 11 information on the printing speed of the driver 12 in a past print job.

If the number of faults in the inspection results of the inspection apparatus 13 in the past print job is equal to or lower than a threshold, the collector 101 collects the printing speed of the printer 12. The threshold may be 0 or 1.

The learning data memory 102 stores multiple pieces of learning data collected by the collector 101.

The learner 103 constructs in accordance with the multiple pieces of learning data a neural network model that receives the input information and estimates the printing speed of the printer 12 in response to the input information.

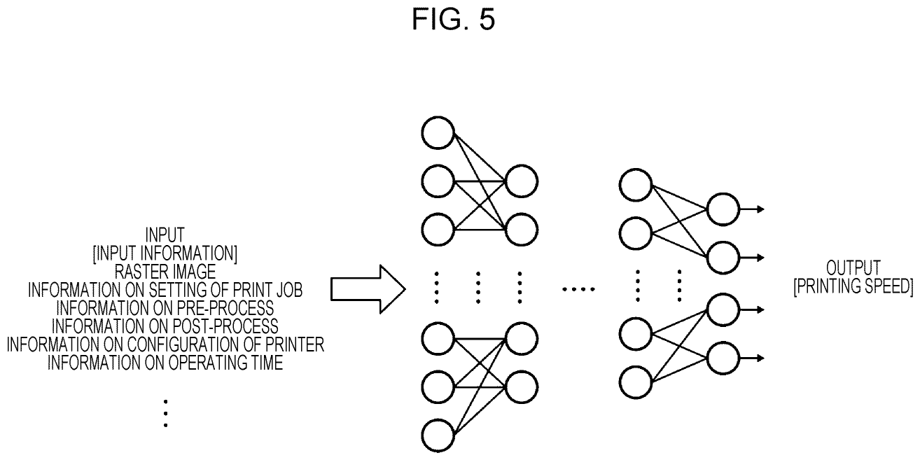

Specifically, the learned neural network model receives the input information that includes at least one piece of the raster image, information on the setting of the print job, information on the pre-process, information on the post-process, information on the configuration of the printer 12, and information on the operating time of the printer 12 and the learned neural network model then outputs the printing speed of the printer 12 in response to the input information (see FIG. 5). Deep learning may be used as an example of an learning algorithm and the neural network model may be constructed such that the printing speed of the learning data is output when the input information of the learning data is received.

Specifically, parameters of the model may be updated in a manner such that the printing speed is estimated as the output of the model with the input information received as the learning data, the estimated printing speed is compared with the printing speed of the learning data, an error between the printing speeds is calculated and the value of the error is minimized.

Correlation between each piece of information included in the input information and the printing speed of the printer 12 is described below.

The raster image may help identify information on a pixel or print position on a sheet, affecting an image quality, and may thus serve as a decision basis for determining the printing speed at which printing may be reliably performed. In this way, a correlation is present between the raster image and the printing speed of the printer 12 that accounts for the inspection results of the inspection apparatus 13.

The information on the setting of the print job may help identify information on a consumable item, a paper sheet path or print paper, each affecting the image quality, and may thus serve as a decision basis for determining the printing speed at which printing may be reliably performed. A correlation is thus present between the information on the setting of the print job and the printing speed of the printer 12 that accounts for the inspection results of the inspection apparatus 13.

The information on the configuration of the printer 12 may help identify the pre-process, post-process, paper sheet path and operating status (durability) of the printer 12, each affecting the image quality and may thus serve as a decision basis for determining the printing speed at which printing may be reliably performed. In this way, a correlation is present between the information on the configuration of the printer 12 and the printing speed of the printer 12 that accounts for the inspection results of the inspection apparatus 13.

The model memory 104 stores the learned neural network model.

The receiver 105 receives the input information on a new print job serving as an estimation target.

The input information may include the information on the print job. Specifically, the information on the print job may include a raster image representing a printed material and generated prior to printing or the information on the setting on the print job. For example, the receiver 105 receives the raster image, “no use” as use or no use status of special toner, “tray 2” as the type of paper feed tray, “90 kg of high-quality paper” as the type of printing paper or “tray 3” as the type of paper output tray, acquired from the management apparatus 11.

The input information may include the information on the printer 12. Specifically, the information on the printer 12 includes the information on the pre-process or post-process, information on the configuration of the printer 12 or information on the operating time of the printer 12. For example, the receiver 105 receives “preprint” as the type of the pre-process, “paper feeding” as the type of the post-process, “distance between apparatuses of 10 m” as the information on the configuration of the printer 12 and “1000 hours” as the cumulative operating time of the printer 12, acquired from the management apparatus 11 or the printer 12.

The estimator 106 estimates the printing speed responsive to the received input information using the learned neural network model stored on the model memory 104.

Specifically, the estimator 106 converts a variety of information included in the received input information into data in a data structure supported by the learned neural network model (such as a scalar value or a vector), inputs the resulting data to the learned neural network model and then estimates the printing speed of the printer 12 from the output of the learned neural network model.

The output unit 107 sets the determined printing speed on the printer 12 as a printing speed of the print job.

If the inspection results indicate a fault when an operator checks the inspection results of the inspection apparatus 13, the operator adjusts the printing speed of the printer 12 to a slower value. The collector 101 may acquire the adjusted printing speed as a correct printing speed and collect the input information on the print job paired with the acquired printing speed.

A specific process of the information processing system 10 of the exemplary embodiment thus configurated is described below.

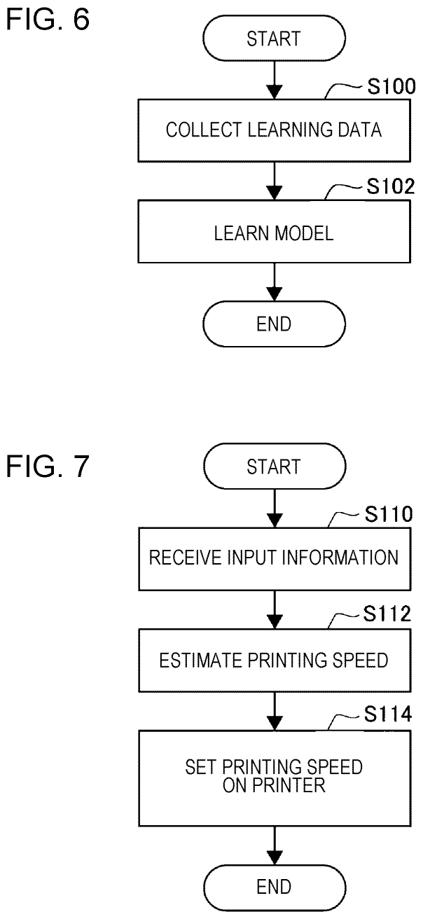

In the client computer 14, a CPU 14A reads a learning program from a ROM 14B or storage 14D, loads the learning program on a RAM 14C and then executes the learning program. The client computer 14 thus performs a learning process illustrated in FIG. 6.

In step S100, the CPU 14A operating as the collector 101 collects learning data including the input information on the past print job paired with the printing speed of the printer 12 responsive to the input information and then stores the learning data on the learning data memory 102.

In step S102, the CPU 14A operating as the learner 103 learns, in accordance with multiple pieces of learning data, a neural network model that receives the input information and estimates the printing speed and then the CPU 14A stores the learned neural network model on the model memory 104 to complete the learning process.

The CPU 14A in the client computer 14 reads an estimation program from the ROM 14B or storage 14D, loads the estimation program on the RAM 14C, executes the estimation program on the RAM 14C and thus performs an estimation process illustrated in FIG. 7. The estimation process is performed before printing a print job serving as an estimation target is performed. It is noted that the variety of information included in the input information on the print job has been input.

In step S110, the CPU 14A operating as the receiver 105 receives the input information input by a user and related to the print job serving as the estimation target.

In step S112, the CPU 14A operating as the estimator 106 estimates the printing speed responsive to the received input information using the learned neural network model stored on the model memory 104.

In step S114, the CPU 14A operating as the output unit 107 sets the estimated printing speed as a printing speed of the print job on the printer 12 and then ends the estimation process. The printer 12 performs the printing process of the print job at the set printing speed.

Through the processes as described above, the printing speed of the print job may be predicted and then set in view of the inspection of the printed material on the printer.

### Modifications

The disclosure is not limited to the exemplary embodiment and may be modified or applied in a variety of forms without departing from the scope of the disclosure.

In the exemplary embodiment, a variety pieces of input information are input to estimate the printing speed. After receiving a subset of, rather than all of, the pieces of input information, the printing speed may be estimated.

In the exemplary embodiment, the client computer 14 estimates the printing speed while learning the model. Alternatively, the client computer 14 may be configurated to be divided into a learning apparatus that learns the model and an estimating apparatus that estimates the printing speed.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

According to the exemplary embodiments, the system is configurated to include multiple apparatuses but alternatively, is configurated to include only a single apparatus having a subset of the functions of the apparatuses.

The process of the printer 12 of the exemplary embodiment may be performed using software, hardware or both. The process of the printer 12 may be stored as a program on a memory and then the memory with the program recorded thereon may be delivered.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:
a processor configured to:
   when new input information including information on a new print job or information on a printer is input to a model, output a printing speed of the new print job, wherein the model has been learned such that a printing speed of a print job is output when input information including information on the print job or information on the printer including an inspection apparatus inspecting a printed material printed in the print job is input to the model.
(((2)))

In the information processing system according to (((1))), the information on the print job includes an image representing a printed material and formed before printing.
(((3)))

In the information processing system according to one of (((1))) and (((2))), the information on the print job includes information on a setting of the print job.
(((4)))

In the information processing system according to one of (((1))) through (((3))), the information on the printer includes information on a pre-process or a post-process, information on a configuration of the printer or information on operating time of the printer.
(((5))

In the information processing system according to one of (((1))) through (((4))), the processor is configured to set the printing speed of the new print job on the printer.
(((6)))

A program causing a computer to execute a process, the process including:
when new input information including information on a new print job or information on a printer is input to a model, outputting a printing speed of the new print job, wherein the model has been learned such that a printing speed of a print job is output when input information including information on the print job or information on the printer including an inspection apparatus inspecting a printed material printed in the print job is input to the model.

What is claimed is:

1. An information processing system comprising:
a processor configured to:
when new input information including information on a new print job or information on a printer is input to a model, output a printing speed of the new print job, wherein the model has been learned such that a printing speed of a print job is output when input information including information on the print job or information on the printer including an inspection apparatus inspecting a printed material printed in the print job is input to the model.

2. The information processing system according to claim 1, wherein the information on the print job comprises an image representing a printed material and formed before printing.

3. The information processing system according to claim 1, wherein the information on the print job comprises information on a setting of the print job.

4. The information processing system according to claim 1, wherein the information on the printer comprises information on a pre-process or a post-process, information on a configuration of the printer or information on operating time of the printer.

5. The information processing system according to claim 1, wherein the processor is configured to set the printing speed of the new print job on the printer.

6. A non-transitory computer readable medium storing a program causing a computer to execute a process, the process comprising:
when new input information including information on a new print job or information on a printer is input to a model, outputting a printing speed of the new print job, wherein the model has been learned such that a printing speed of a print job is output when input information including information on the print job or information on the printer including an inspection apparatus inspecting a printed material printed in the print job is input to the model.

7. An information processing method comprising:
when new input information including information on a new print job or information on a printer is input to a model, outputting a printing speed of the new print job, wherein the model has been learned such that a printing speed of a print job is output when input information including information on the print job or information on the printer including an inspection apparatus inspecting a printed material printed in the print job is input to the model.
